(19) United States
(12) Patent Application Publication
(10) Pub. No.: US 2014/0025869 A1
(43) Pub. Date: Jan. 23, 2014

(54) METHOD AND SYSTEM FOR IMPROVING A CONTROL OF A LIMIT ON WRITING CYCLES OF AN IC CARD

(71) Applicants: Amedeo Veneroso, Caserta (IT); Francesco Varone, Bellona (IT); Vitantonio Distasio, Caserta (IT); Pasquale Vastano, Caserta (IT)

(72) Inventors: Amedeo Veneroso, Caserta (IT); Francesco Varone, Bellona (IT); Vitantonio Distasio, Caserta (IT); Pasquale Vastano, Caserta (IT)

(73) Assignee: STMICROELECTRONICS INTERNATIONAL NV, Geneva (CH)

(21) Appl. No.: 13/976,686

(22) PCT Filed: Dec. 23, 2011
(86) PCT No.: PCT/EP11/06554

§ 371 Date: Oct. 1, 2013

(30) Foreign Application Priority Data
Dec. 30, 2010 (IT) MI2010A002475

(51) Int. Cl. G06F 12/02

(52) U.S. Cl. CPC G06F 12/0246
USPC 711/103

(57) ABSTRACT

The present invention relates to a method and system for controlling a number of writing cycles supported by a cell or portion (11) of a non volatile memory (4) of an IC Card (10), including the steps of counting write accesses to the memory portion (11) and storing a first counter (21) of the write accesses in another portion (21) of said non volatile memory (4). The method comprises coupling the first counter (21) to a second counter or value (31) associated to a RAM (4) (Random Access Memory) of the IC Card (10), wherein the second counter or value (31) is updated each time the write accesses occur on said cell or portion (11) to be controlled and the first counter (21) is written in the another portion of non volatile memory only when the second counter or value (21) corresponds to a predetermined value.

### FIELD OF THE INVENTION

The present disclosure relates a method and system for limiting write cycles of an integrated circuit (IC) card.

### BACKGROUND OF THE INVENTION

Some volatile memory technologies, such as Electrically Erasable Programmable Read Only Memory (EEPROM) and Flash, include a plurality of memory portions or memory cells supporting a limited number of write cycles. More particularly, if the memory cell is written to more than a predetermined number of times, i.e. more than a predetermined number of write cycles are executed on the same cell, it is no longer considered reliable. In fact, data stored therein may be lost or an access to the cell denied. For example, a non-volatile memory may be guaranteed to support no more than 100,000 write cycles on the same cell.

A method to provide a limit on write cycles of the non-volatile memory of the IC Card may include a counter, inside the non-volatile memory, for counting how many write cycles are executed on a same cell or portion. For example, this counter may be incremented each time a write cycle occurs on the cell. When the counter reaches a predetermined value, the memory cell is no longer considered reliable, and a recovery procedure is triggered on the non-volatile memory. With reference to the example given above, the predetermined value may be, for example, 50,000.

However, this method may suffer from the same problem that the non-volatile memory, where the counter value is stored, is subject to limitations on the number of write cycles, i.e. the storing of the limit value may be compromised. Moreover, the control of the limitations on the number of write cycles over a plurality of memory cells may require a corresponding plurality of counters associated to the memory cells; thus, wide areas of the non-volatile memory are consumed by the counters, since they are frequently written and rapidly reach the respective limit on write cycles supported.

### SUMMARY OF THE INVENTION

In view of the foregoing background, it is therefore an object of the invention to provide a method and a system for controlling the limits on the number of write cycles supported by an IC Card which is based on a counter not suffering the same limitation of the other portions of non-volatile memory and which may have a longer duration. This may provide an approach to the limitation that currently affects the typical method and systems.

The approach of the present disclosure is to save, inside the non-volatile memory of an IC Card, a counter for controlling limits on write cycles of a memory cell or portion. The counter may be updated only one time for a predetermined number of write cycles executed over the corresponding cell or portion. Advantageously, there is a predetermined ratio between a number of write cycles executed on the non-volatile memory of the counter and a number of write cycles executed on the cell or portions of non-volatile memory to be controlled with the counter. More particularly, the lifetime of the counter is longer than the lifetime of the memory cell or portion controlled thereby; thus, when the controlled memory cell is exhausted because it is not capable of supporting further write cycles, the counter may be decoupled from such memory cell and associated to another memory cell or portion to be controlled. Advantageously, the memory damaged by the counter, due to the respective write cycles, may be reduced.

According to this approach, a method is for controlling a number of write cycles supported by a cell or portion of a non-volatile memory of an IC Card. The method may include counting write accesses to the memory portion and storing a first counter of the write accesses in another portion of the non-volatile memory. The first counter may be coupled to a second counter or value associated to a random access memory (RAM) of the IC Card. The second counter or value may be updated each time the write access occurs on the cell or portion to be controlled, and the first counter is written in another portion of the non-volatile memory only when the second counter or value corresponds to a predetermined value.

Advantageously, the second counter or value may not be limited by the same hardware constraints of the first counter since it is included in the RAM portion of the IC Card and not in the non-volatile memory. Moreover, the access to the RAM is faster, and thus the second counter or value may be updated faster that the first counter. This may improve the performance of the method for controlling the write cycles, since the first counter is updated only once for N predetermined updates of the second counter or value.

Further advantages and features of the present disclosure are apparent from the description given below and from the annexed drawings which are given only for exemplificative purpose and without limiting the scope of protection of the present disclosure.

### BRIEF DESCRIPTION OF THE DRAWINGS

FIG. 1 is a schematic block diagram representing a method, according to the preset invention.

### DETAILED DESCRIPTION OF THE PREFERRED EMBODIMENTS

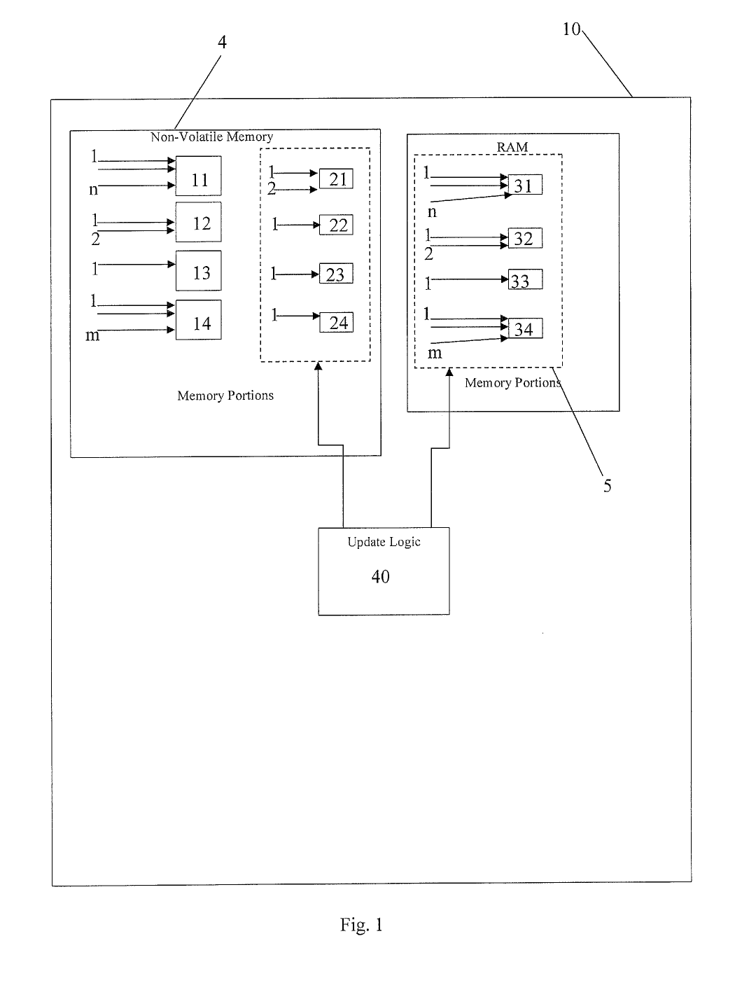

With reference to FIG. 1, an IC Card 10 according to the present disclosure illustratively includes a non-volatile memory 4 and a RAM 5. The non-volatile memory 4 comprises a plurality of memory portions or memory cells 11, 12, 13, 14, 21, 22, 23, 24 where data is stored and maintained also after the IC card is powered off. Also, the RAM comprises a plurality of memory portions or cells 31, 32, 33, 34 where data is stored; however, the memory cells of the RAM do not maintain data if the IC Card is powered off. Each non-volatile memory portion supports a limited number of write cycles, for example, 100,000 write cycles, after which the storage or access of data is not guaranteed.

For guaranteeing the reliability of the IC Card, a method is provided which controls a limit of the write cycles on the memory cells or portions of the non-volatile memory 4. More particularly, the memory cell 11 is coupled to a first counter 21 storing a value associated to a number of write cycles on the memory cell, indicating how many times the memory cell has been involved in a write cycle. Also the value of the first counter 21 is stored in the non-volatile memory 4, and thus it is subject to the same memory constrains, i.e. to the same limitation of the write cycles, of the memory cell 11. More particularly, the method for controlling the number of write cycles supported by the cell or portion 11 includes the steps of counting write accesses to the memory cell or portion 11 and associating the first counter 21 to another portion 21 of the non-volatile memory 4.

According to the present disclosure, the method comprises coupling the first counter 21 to a second counter or value 31 associated to the RAM 5 of the IC Card. The second counter 31 is updated each time the write accesses occur on the cell or portion to be controlled, and the first counter 21 is written in the another portion 21 of non-volatile memory 4 only when the second counter or value 31 corresponds to a predetermined value.

Advantageously, the second counter 31 in the RAM 5 is not subject to the same memory constrains, i.e. to the same limitation on the number of write cycles, of the first counter 21 in non-volatile memory 4. According to the method, the number of write cycles executed on the first counter 21 is less than the number of write cycles executed on the memory portion 11 to which it is associated for control. Thus, when the memory portion 11 is considered to be unreliable because it has been written a number of times substantially corresponding to the supported limit, the first counter 21 may be reused to control other memory cells or portions. This may avoid damaging areas of non-volatile memory 4, since a same memory portion of non-volatile memory 4 used for the first counter 21 is reused for controlling several memory cells or portions 11, 12, 13, 14 of the same non-volatile memory portion 4.

According to an aspect of the present disclosure, the update of the second counter 31 comprises incrementing a value of the second counter 31 from a lower value x to an upper value y or decrementing the value from an upper value y to a lower value x. When the upper value y is reached in the case of increment or the lower value x is reached in the case of decrement, the second counter 31 is reset to the lower value x or the upper value y, respectively. For example, the predetermined value of the second counter 31, which triggers the writing of the first counter 21, corresponds to the upper value x or the lower value y, respectively. For example, the lower limit x is 0, the upper limit y is 100, and the second counter 31 is incremented with a step of 1 for each writing cycle on the memory portion 11, to which the first counter 21 is associated. In this case, the first counter 21 is written once for each hundred of updates on the second counter 31. In other words, the write cycles of the first counter 21 are 1/100 of the updates executed on the second counter 31 and 1/100 of the write cycles on the cell or portion 11 of the non-volatile memory 4. More particularly, according to this aspect of the invention, the write cycles of the first counter 21 are 1/(y−x) times the updates of the second counters 31. In the case where the second counter 31 counts from 1 to n, the number of write cycles of the first counter 21 in the corresponding portion 21 of non-volatile memory 4 is 1/n times the number of updates of the second counter 31.

According to another aspect of the present disclosure, the value 31 is selected among a prescribed plurality of values, where a predetermined selected value of the prescribed plurality of values triggers the writing of the first counter 21. More particularly, the value 31 is randomly selected between m values of the prescribed plurality of values; thus, a number of write cycles of the first counter 21 in the corresponding portion 21 of non-volatile memory substantially correspond to 1/m times a number of updates of the value 31. In fact, the probability of randomly selecting the predetermined value among the prescribed plurality of values m is 1/m.

Advantageously, according to this aspect of the present disclosure, it is not required to store the value 31 and to increment it at each write cycle of the portion 11 to be controlled. In fact, at each write cycle of such cell or portion 11, the value 31 is randomly selected among the prescribed plurality of values, for example, 1-100, and the selected value is compared with the predetermined one of the prescribed plurality of values, for instance, the value 57 (fifty seven). If the selected value corresponds to the predetermined value, the first counter 21 is incremented, otherwise the write cycle of the cell or portion 11 is executed and the first counter 21 is not written. The probability of selecting the predetermined value, i.e. the value 57, among the prescribed plurality of values, i.e. among 1-100, supposing the random generator function to have the property of uniform distribution, is 1/m ( 1/100). Statistically, after an execution of 100,000 write cycles, the first counter 21 is incremented, i.e. it is written, only 100 times. Thus, the corresponding memory portion 21 is not considered unreliable when the controlled memory portion 11 is considered unreliable.

According to an aspect of the invention, each memory cell 11, 12, 13, 14 or portion of the non-volatile memory 4 is associated to a corresponding first counter 21, 22, 23, 24 in the non-volatile memory 4 and a second counter or value 31, 32, 33, 34 in RAM 5 is coupled to the corresponding first counter 21, 22, 23, 24, for controlling a number of write cycles supported by the entire non-volatile memory 4. Thus, the memory area associated to the first counters 21, 22, 23, 24 which control the other areas 11, 12, 13, 14 of non-volatile memory 4 is not subject to a same frequency of write cycles to which such other areas are exposed.

According to the present disclosure, when the method detects that a memory cell or portion has been written to up to the limit, it moves the corresponding data to a less stressed memory cell or portion. In particular, the first counter 21 is compared with a predetermined value L which is associated to a limit of write cycles supported by the portion 11 of non-volatile memory 4, for example, L=100,000, and a warning on a maximum data update on the portion 11 is triggered by an application or an operation system of the IC Card, whether the first counter 21 exceeds the predetermined value L. The step of comparing includes taking in consideration a scale factor between the second counter or value 31 and the first counter 21. For example, if the first counter 21 is incremented one time every N updates of the second counter or value 31, the scale factor is N and thus a value T stored in the first counter 21 is multiplied for the scale factor N to retrieve the write cycles effectively executed on the controlled memory portion 11. For instance, if the scale factor is 100, i.e. the first counter 21 is incremented one time every 100 updates of the second counter or value 31, a value of 13 (thirteen) stored in the first counter corresponds to 13,000 write cycles in the controlled memory portion 11. When the memory portion has been written up to the limit, the corresponding data is moved into a different portion of the non-volatile memory.

Preferably, the different portion is associated to another first counter 22 having a value not exceeding the predetermined value L, more preferably to the first counter 22 with the lowest value. The first counter 22 was associated to another memory portion, for example, to the memory portion 12, meanwhile considered unreliable because it has been written up to its respective limit.

An approach to the above mentioned technical problem may comprise an IC Card 10 according to the present disclosure including a non-volatile memory 4, and a first counter 21 for counting write accesses to a cell or portion 11 of the non-volatile memory 4. The first counter 21 is stored in another portion 21 of the non-volatile memory 4, the portion of such memory 4 being subject to the same memory constrains, i.e. they support a same limited number of write cycles.

According to the invention, the IC Card 10 comprises a second counter or value 31 coupled to the first counter 21 and included in a RAM 4 of the IC Card 10, and an update logic for updating 40 the second counter or value 31 each time the write accesses occur on the cell or portion to be controlled and for writing the first counter 21 only when the second counter or value 31 corresponds to a predetermined value.

More particularly, the update logic 40 comprises incrementing a value of the second counter 31 from a lower value x to an upper value y or decrementing the value from an upper value y to a lower value x, and writing the first counter 21 only if the second counter 31 corresponds to the upper value y or the lower value x, respectively. In a preferred embodiment, the second counter 31 is set from 1 to n so that a number of write cycles of the first counter 21 in the another portion 21 of non-volatile memory 4 is 1/n times a number of updates of the second counter 31.

In an aspect of the invention, the update logic 40 comprises selecting a value 31 among a prescribed plurality of values, and writing the first counter 21 when the value 31 corresponds to one specific value of the prescribed plurality of values. More particularly, the update logic includes a random generator of a value 1 . . . m for the value 31, and a comparator for comparing the randomly selected number with the predetermined among the prescribed plurality of values.

As schematically shown in FIG. 1, each memory cell or portion 11, 12, 13, 14 of the non-volatile memory 4 is associated to a corresponding first counter 21, 22, 23, 24 in the non-volatile memory 4, and to a second counter or value 31, 32, 33, 34 in RAM 5, which is coupled to the corresponding first counter 21, 22, 23, 24. The comparator has as an input the first counter 21 and a predetermined value L which is associated to a limit of write cycles supported by the cell or portion 11 of non-volatile memory 4, and triggers a warning on a maximum data update on the portion 11 if the first counter 21 exceeds the predetermined value. Thus, the operative system of the IC card may move data from the memory cell or portion, which is detected to be unreliable, to another memory portion.

Advantageously, according to the method and system of the present disclosure, a predetermined ratio between a number of write cycles executed on the non-volatile memory associated to the first counter and a number of write cycles executed on the cell or portion of non-volatile memory to be controlled with the first counter can be set, thus reducing the stress of the memory portion of the counters. The lifetime of the counter is longer than the lifetime of the portion of memory portion controlled; thus, when the controlled memory portion cannot support further write cycles, i.e. it reaches the respective limit of write cycles, the counter may be decoupled from the memory portion and associated to another memory portion to be controlled. Advantageously, the memory portions associated to counter and damaged due to the write cycles of the counter is reduced.

Advantageously, the second counter or value is not limited by the same hardware constrains of the first counter since the former is included in the RAM portion of the IC Card and not in the non-volatile memory. Advantageously, the access to the RAM is faster and thus the second counter or value may be updated faster that the first counter, also improving the performance of the write cycle of the controlled non-volatile memory portion. This improves the performance of the method for controlling the write cycles numbers, since the first counter is updated once for N updates of the second counter or value.

1-15. (canceled)

16. A method for controlling a number of write cycles for a portion of a non-volatile memory of an integrated circuit (IC) Card, the method comprising:
counting write accesses to the portion of the non-volatile memory;
storing a first counter value of the write accesses in an other portion of the non-volatile memory, the first counter value being associated with a second counter value stored in a Random Access Memory (RAM) of the IC Card;
updating the second counter value for each write access on the portion of the non-volatile memory; and
writing the first counter value in the other portion of non-volatile memory when the second counter value corresponds to a threshold value.

17. The method according to claim 16 wherein updating the second counter value comprises incrementing a value of the second counter value from a lower value to an upper value or decrementing the value of the second counter value from the upper value to the lower value, the threshold value corresponding to the upper value or the lower value, respectively.

18. The method according to claim 17 wherein the second counter value counts from 1 to n; and wherein a number of write cycles of the first counter value in the other portion of non-volatile memory is 1/n times a number of updates of the second counter value.

19. The method according to claim 16 wherein updating of the second counter value comprises selecting the threshold value from among a plurality of values.

20. The method according to claim 19 wherein the threshold value is randomly selected between m values of the plurality of values; and wherein a number of write cycles of the first counter value in the other portion of non-volatile memory is 1/m times a number of updates of the second counter value.

21. The method according to claim 16 wherein each portion of the non-volatile memory is associated to a corresponding first counter value in the non-volatile memory and a second counter value in the RAM associated with the corresponding first counter value for controlling a number of write cycles to the respective portion of the non-volatile memory.

22. The method according to claim 16 further comprising:
comparing the first counter value with a limit value associated to a limit of write cycles for the portion of non-volatile memory; and
triggering a warning for the portion of the non-volatile memory by an application of the IC Card when the first counter value exceeds the limit value.

23. The method according to claim 22 further comprising moving data stored in the portion of non-volatile memory into a different portion of the non-volatile memory, the different portion being associated to a corresponding first counter value having a value not exceeding the limit value

24. The method according to claim 23 wherein the value of the corresponding first counter value is lower than the limit value.

25. A method for controlling a number of write cycles for a portion of a non-volatile memory of an integrated circuit (IC) Card, the method comprising:
counting write accesses to the portion of the non-volatile memory;
storing a first counter value of the write accesses in an other portion of the non-volatile memory, the first counter value being associated with a second counter value stored in a Random Access Memory (RAM) of the IC Card, the second counter value comprising a random value; and
writing the first counter value in the other portion of non-volatile memory when the second counter value corresponds to a threshold value.

26. The method according to claim 25 wherein each portion of the non-volatile memory is associated to a corresponding first counter value in the non-volatile memory and a second counter value in the RAM associated with the corresponding first counter value for controlling a number of write cycles to the respective portion of the non-volatile memory.

27. The method according to claim 25 further comprising:
comparing the first counter value with a limit value associated to a limit of write cycles for the portion of non-volatile memory; and
triggering a warning for the portion of the non-volatile memory by an application of the IC Card when the first counter value exceeds the limit value.

28. The method according to claim 27 further comprising moving data stored in the portion of non-volatile memory into a different portion of the non-volatile memory, the different portion being associated to a corresponding first counter value having a value not exceeding the limit value

29. An integrated circuit (IC) for an IC card comprising:
a non-volatile memory comprising a portion, and an other portion, said other portion being configured to store a first counter value for counting write accesses to the portion; and
a random access memory (RAM) configured to store a second counter value associated with the first counter value; and
an update logic block configured to update the second counter value for each write access to said portion and write to the first counter value when the second counter value corresponds to a threshold value.

30. The IC according to claim 29 wherein said update logic block is configured to:
increment the second counter value from a lower value to an upper value or decrement the second counter value from the upper value to the lower value; and
write to the first counter value when the second counter value corresponds to the upper value or the lower value, respectively.

31. The IC according to claim 30 wherein the value of the second counter value is set from 1 to n; and wherein a number of write cycles to the first counter value in said other portion is 1/n times a number of updates of the second counter value.

32. The IC according to claim 29 wherein said update logic block is configured to select the threshold value from among a plurality of values, and write to the first counter value when the selected value corresponds to the second counter value.

33. The IC according to claim 32 wherein said update logic block is configured to randomly select the threshold value.

34. The IC according to claim 29 wherein each portion is associated to a corresponding first counter value in said non-volatile memory and to a second counter value in said RAM associated with the corresponding first counter value.

35. The IC according to claim 34 further comprising a comparator configured to compare the first counter value and a limit value associated to a limit of write cycles for said portion, and trigger a warning for said portion if the first counter value exceeds the limit value.

36. An integrated circuit (IC) for an IC card comprising:
a non-volatile memory comprising a portion, and an other portion, said other portion being configured to store a first counter value for counting write accesses to the portion; and
a random access memory (RAM) configured to store a second counter value associated with the first counter value, the second counter value comprising a random value; and
an update logic block configured to write to the first counter value when the second counter value corresponds to a threshold value.

37. The IC according to claim 36 wherein each portion is associated to a corresponding first counter value in said non-volatile memory and to a corresponding second counter value in said RAM associated with the corresponding first counter value.

38. The IC according to claim 37 further comprising a comparator configured to compare the first counter value and a limit value associated to a limit of write cycles for said portion, and trigger a warning for said portion if the first counter value exceeds the limit value.
